(19) United States
(12) Patent Application Publication
(10) Pub. No.: US 2021/0112956 A1
(43) Pub. Date: Apr. 22, 2021

(54) PENCIL HOLDER

(71) Applicant: Daniel J. Miller, El Segundo, CA (US)

(72) Inventor: Daniel J. Miller, El Segundo, CA (US)

(21) Appl. No.: 17/076,773

(22) Filed: Oct. 21, 2020

Related U.S. Application Data
(60) Provisional application No. 62/924,288, filed on Oct. 22, 2019.

(51) Int. Cl. A45F 5/00; B43K 25/02

(52) U.S. Cl. CPC A45F 5/00; A45F 2005/006; B43K 25/024

(57) ABSTRACT

The present disclosure provides a pencil holder that can carry a contractor's pencil, marker or construction crayon on the user's body. The pencil holder includes a lanyard connector portion that has a lanyard attached thereto. A pencil connector portion is included that is selectively attachable with the lanyard connector portion. A cavity is formed within the pencil connector portion to securely affix a writing implement therein. To allow for selective attachment and detachment between the pencil connector and lanyard connector portions, each of the components have magnet holes therein that securely hold a pair of magnets.

### CROSS-REFERENCE TO RELATED APPLICATIONS

This is a non-provisional application of U.S. Provisional Application No. 62/924,288, filed on Oct. 22, 2019, the entirety of which is incorporated herein by reference.

### BACKGROUND OF THE INVENTION

### (1) Field of Invention

The present invention relates to a pencil holder and, more particularly, to a lanyard having a pencil holder that can carry a contractor's pencil, marker, ink pen, or construction crayon on the user's body.

### (2) Description of Related Art

While working or otherwise on a job site, contractors often need a pencil or marking utensil to easily mark cutting surfaces and other items. Some holders have been devised to assist the contractor in maintaining possession of the pencil. For example, a belt clip with a pull cord was conceived that maintains the pencil proximate the user's belt. While generally operable, such existing holders have limitations. By way of example, the belt clip device requires that the user have the foresight of wearing a belt. If by chance the contractor fails to wear such a belt, the belt clip device is difficult if not impossible to use.

Thus, a continuing need exists for a new and improved pencil holder.

### SUMMARY OF INVENTION

The present disclosure provides a pencil holder that can carry a contractor's pencil, marker or construction crayon on the user's body. The pencil holder includes a lanyard connector portion that has a lanyard attached thereto. A pencil connector portion is included that is selectively attachable with the lanyard connector portion. A cavity is formed within the pencil connector portion to securely affix a writing implement therein. To allow for selective attachment and detachment between the pencil connector and lanyard connector portions, each of the components have magnet holes therein that securely hold a pair of magnets.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a pencil holder according to various embodiments of the present invention;

FIG. 2 is an illustration of the pencil holder, depicting both a lanyard and pencil as affixed with the pencil holder;

FIG. 3 is an illustration of the pencil holder, depicting a lanyard connector portion as separated from a pencil connector portion;

FIG. 4 is a side-view illustration of the pencil holder; and

FIG. 5 is a wire-frame illustration of the pencil holder.

### DETAILED DESCRIPTION

The present invention relates to a pencil holder and, more particularly, to a lanyard having a pencil holder that can carry a contractor's pencil, marker or construction crayon on the user's body. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

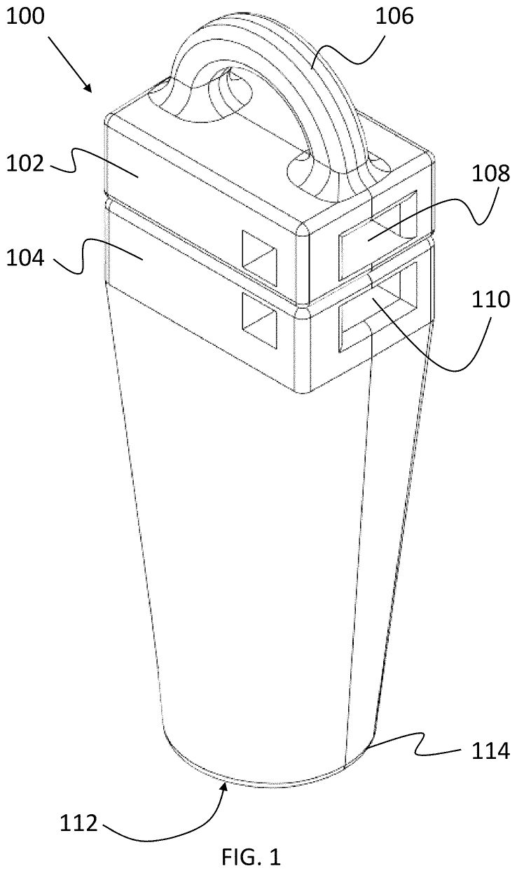

As shown in FIG. 1, the present disclosure is directed to a pencil holder 100 that is formed to hold writing implement such as a contractor's pencil, marker or construction crayon. The pencil holder 100 includes at least a first portion (e.g., lanyard connector portion 102) and a second portion (e.g., pencil connector portion 104). The lanyard connector and pencil connector portions 102 and 104 are formed to be detachably attachable with one another using any suitable mechanism, technique, or device.

The lanyard connector portion 102 is also formed to include a catch 106. The catch 106 is any suitable shape, mechanism, or device that allows a lanyard to be affixed with the lanyard connector portion 102. For example and as depicted, the catch 106 is a loop that is integrally molded with the lanyard connector portion 102.

Further, the pencil connector portion 104 is formed to receive and securely hold a writing implement (e.g., pencil, marker, crayon, pen, etc.). For example, the pencil connector portion 104 has a hole or aperture formed therein in which a pencil or other writing implement can be press fit to securely affix with the pencil connector portion 104. In one aspect, the pencil connector portion 104 includes a cavity 112 that receives and securely holds the writing implement. As a non-limiting example, the cavity 112 is a cylindrical shape that is molded into the pencil connector portion 104 with access to the cavity 112 at a bottom side 114 of the pencil connector portion 104. Thus, the writing implement can be press fit into the cavity 112 and affixed therein.

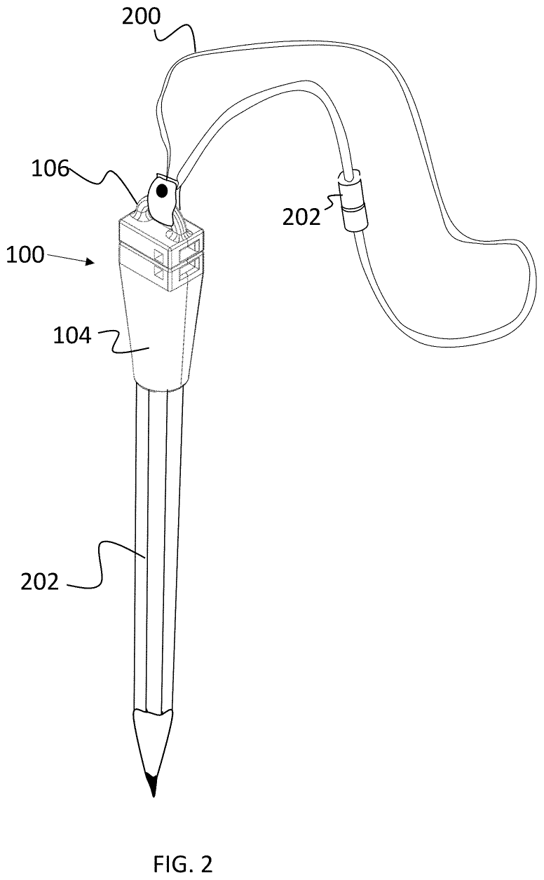

As shown in FIG. 2, a lanyard 200 or other strap or device can be affixed with the catch 106. A non-limiting example of a suitable lanyard 200 is depicted in FIG. 2. In this example, the lanyard 200 has a breakaway device 204 for safety and will have a length adjuster. Also as shown, the writing implement 202 is press fit into and affixed with the pencil connector portion 104 of the pencil holder 100. Through use of the lanyard 200, a user can carry the writing implement 202 (e.g., contractor's pencil, marker or construction crayon) on the user's body instead of constantly trying to locate said items in the field.

Notably, the pencil connector portion 104 is formed to selectively attach/detach from the lanyard connector portion 102. The two components are formed in any suitable matter to allow for selective attachment/detachment between the two components. As a non-limiting example, the two components are formed to include hook and loop fasteners, such as Velcro®. As can be appreciated by those skilled in the art, there are a number of techniques that can be implemented to allow for such selective attachment/detachment.

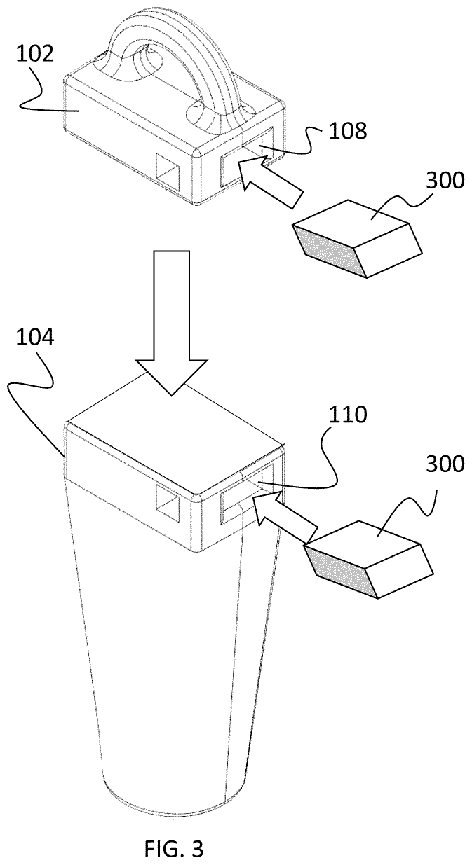

Desirably and as shown between FIGS. 1 and 3, the lanyard connector portion 102 and pencil connector portion 104 are formed to include magnets 300 therein that provide for the connecting force to maintain the two components connected with one another. Thus, in this example, when the user pulls on a pencil with sufficient force to overcome the magnetic attraction between the two magnets 300, the pencil connector portion 104 is pulled from the lanyard connector portion 102 to allow the user to freely use the pencil or writing implement.

In other words, in this example, the lanyard connector and pencil connector portions 102 and 104 include magnets 300 embedded therein that allow the lanyard connector and pencil connector portions 102 and 104 to be magnetically connectable with one another. In one aspect, each of the lanyard connector and pencil connector portions 102 and 104 include magnet holes 108 and 110, respectively, that are formed to accommodate magnets 300. For example, the magnets 300 can be press fit, glued, or otherwise adhered in each of the magnet holes 108 and 110.

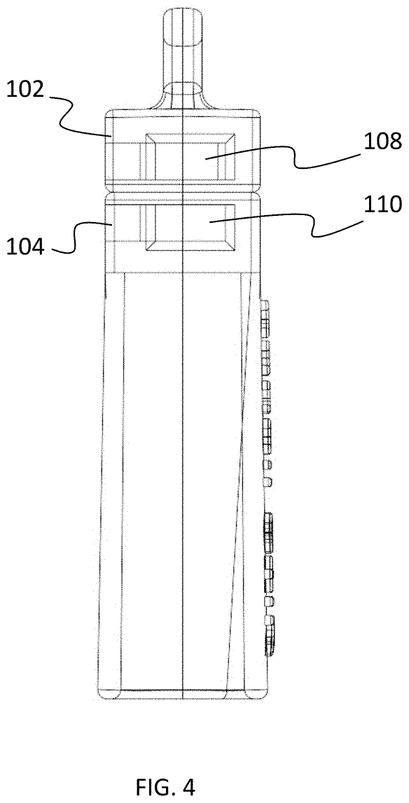

For further understanding, FIG. 4 provides a side view illustration of the pencil holder 100, depicting the magnet holes 108 and 110 formed in each of the lanyard connector and pencil connector portions 102 and 104.

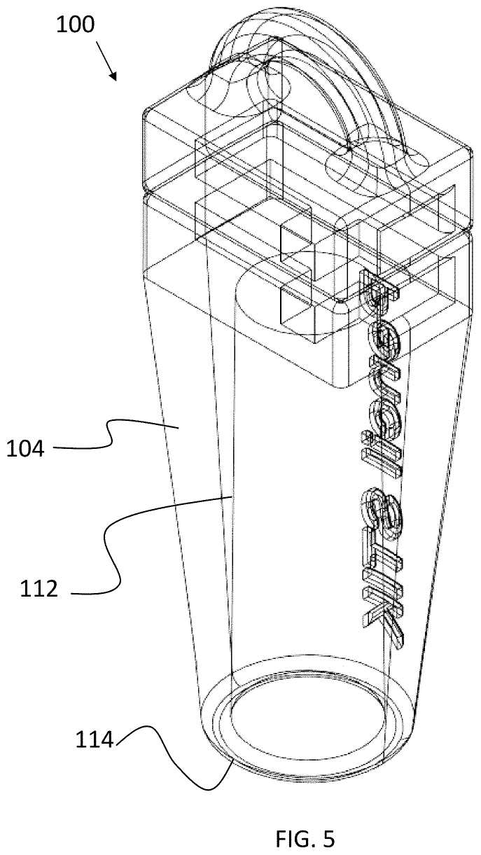

Finally, FIG. 5 provides a wire-frame illustration of the pencil holder 100, depicting an interior of the pencil holder 100 to illustrate the cavity 112 as formed therein. As shown, the cavity 112 extends is accessible via the bottom side 114 of the pencil connector portion 104 to allow a writing implement to be positioned therein.

It should be understood that the lanyard connector portion 102 and pencil connector portion 104 can be formed from any suitable material and in any suitable manner to provide the functions as described herein. As a non-limiting example, the components 102 and 104 are molded from thermal plastic polyurethane (TPE), and the magnets 300 can be any desired shape (e.g., round, rectangular, etc.) or strength. In one aspect, the magnets 300 are positioned in place with remaining material (such as TPE or rubber, etc.) being injection molded around the magnets 300 or otherwise formed around the magnets. In yet another example, the components 102 and 104 can be formed with the magnets later positioned therein. For example and as noted above, each of the lanyard connector portion 102 and pencil connector portion 104 can be molded or otherwise formed to have a space (e.g., magnet holes 108 and 110) to accommodate a magnet 300 that is press fit into the space. As yet another non-limiting example, slits can be formed in each of the pencil connector portion 102 and lanyard connector portion 104 to allow for a space to press fit the magnets 300.

It should also be noted that while the term “lanyard” is used generally to describe a device that hangs around a user's neck, the invention is not intended to be limited thereto as the lanyard 200 can be replaced with any other suitable item that allows for carrying by a user. For example, the “lanyard” can be replaced with a bracelet or belt, or other suitable item.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A pencil holder, comprising:
a lanyard connector portion; and
a pencil connector portion, the pencil connector portion being selectively attachable with the lanyard connector portion and having a cavity formed therein, the cavity being adapted to securely affix a writing implement therein.

2. The pencil holder as set forth in claim 1, further comprising a lanyard attached with the lanyard connector portion.

3. The pencil holder as set forth in claim 2, further comprising a pair of magnets, the pair of magnets positioned within the lanyard connector portion and pencil connector portion to allow for selective attachment and detachment between the lanyard connector portion and pencil connector portion.

4. The pencil holder as set forth in claim 2, wherein each of the lanyard connector portion and pencil connector portion have magnet holes therein to securely hold the pair of magnets.

5. The pencil holder as set forth in claim 1, further comprising a pair of magnets, the pair of magnets positioned within the lanyard connector portion and pencil connector portion to allow for selective attachment and detachment between the lanyard connector portion and pencil connector portion.

6. The pencil holder as set forth in claim 5, wherein each of the lanyard connector portion and pencil connector portion have magnet holes therein to securely hold the pair of magnets.
